(19) United States
(12) Patent Application Publication
(10) Pub. No.: US 2002/0194995 A1
(43) Pub. Date: Dec. 26, 2002

(54) Retaining box, and a feeding apparatus of a semiconductor wafer, which can feed or retain a semiconductor wafer without any contamination of the semiconductor wafer caused by a hydrocarbon in air and a hydrocarbon generated from a retaining box

(76) Inventor: Yoshimi Shiramizu, Tokyo (JP)

Correspondence Address: WHITHAM, CURTIS & CHRISTOFFERSON, P.C., SUITE 340, 11491 SUNSET HILLS ROAD, P.O. BOX 9204, RESTON, VA, 20190, US

(21) Appl. No.: 10/167,481

(22) Filed: Jun. 13, 2002

(30) Foreign Application Priority Data
Jun. 20, 2001 (JP) 185943/2001

(51) Int. Cl. B01D 46/00

(52) U.S. Cl. 95/273; 55/385.1

(57) ABSTRACT

A retaining box of a semiconductor wafer, includes an air supply port and an exhaust port. The air supply port has a piping joint and a first filter. Air is forcedly supplied through the air supply port. The exhaust port has a second filter. Inner air inside the retaining box is exhausted from the exhaust port. The retaining box accommodates a plurality of semiconductor wafers in an interval between each other.

### BACKGROUND OF THE INVENTION

1. Field of the Invention

The present invention relates to a retaining box, a feeding apparatus, a feeding method and a retaining warehouse of a semiconductor wafer, and more particularly, relates to a technique for protecting a semiconductor wafer from molecules, gas components and particles such as organic matters and the like, during the retaining and the feeding thereof.

2. Description of the Related Art

The necessity of protecting a semiconductor wafer from contamination caused by molecules, gas components and particles in atmosphere has been increased in association with a higher density and a higher miniaturization of a semiconductor apparatus. From this viewpoint, the cleanliness level of the space in which the semiconductor wafer is treated is very improved in an etching apparatus and a CVD apparatus that are used to manufacture the semiconductor apparatus.

Conventionally, a semiconductor wafer retaining box (a feeding box) has been used when the semiconductor wafer is fed between respective processes for treating the semiconductor wafer. FIG. 1 is a section view showing a conventional semiconductor wafer retaining box 10A in a condition that it accommodates a semiconductor wafer 14. As shown in FIG. 1, in the wafer retaining box 10A of a 300 mm size, a plurality of semiconductor wafers 14 are horizontally placed in an interval between each other. A door 11 to accommodate/take out the semiconductor wafer is placed on a front surface of the retaining box 10A. Also, a sucking/exhausting port 13A having a filter (a breeding filter) is formed in the vicinity of the bottom. When the semiconductor wafer 14 is accommodated, the retaining box 10A is filled with clean room atmosphere or nitrogen gas so that the semiconductor wafer 14 is protected from external particles. The retaining box 10A is typically made of resin material, such as polycarbonate and the like.

FIG. 2 is a diagrammatical section view showing the manner when the semiconductor wafers 14 are taken out from the semiconductor wafer retaining box 10A. When the semiconductor wafers 14 are taken out, a load port 30 is used to take out the semiconductor wafers 14, one by one. Before the door of the retaining box 10A is opened, a clean air 35 is supplied from above the load port 30 by a blower unit 31. The clean air 35 is sealed by the air flow between a feeding opening of the load port 30 and an open portion of the door of the retaining box 10A. Also, a part of this air flows out through a sucking/exhausting port 13A of the retaining box 10A. This air flow protects the external particles from invading the retaining box 10A.

A thesis published in [18-th Air Cleaning And Contamination Control Research Convention (April 20 to 21, 2000), namely, [Simultaneous Removal of Gas And Particle through Cleaning/Optical Catalyst in 300 mm Wafer Feeding Box And UV/Optical Electron Method] discloses a mechanism that polymeric hydrocarbon, which is suspended matter in air, is selectively deposited on the wafer surface, and even within a closed type 300 mm wafer retaining box, slight gas is generated, and hydrocarbon such as phthalate ester and the like is deposited on the wafer surface. The above thesis discloses an example that the cleaning unit using the UV/optical electron method using the optical catalyst protects the contamination in the retaining box.

The technique disclosed in the above thesis installs electrodes and a UV lamp for generating optical electrons and the like, in the retaining box of the semiconductor wafer, and further uses the optical catalyst. Thus, it protects the organic gas generated from the retaining box from being deposited on the semiconductor wafer. However, there may be a fear that the cost of the retaining and the feeding of the wafer is sharply increased since those apparatuses and the optical catalyst are used in the individual retaining box.

### SUMMARY OF THE INVENTION

The present invention is accomplished in view of the above mentioned problems. Therefore, an object of the present invention is to provide a retaining box, a feeding apparatus, a feeding method and a retaining warehouse of a semiconductor wafer, which can feed or retain a semiconductor wafer without any contamination of the semiconductor wafer caused by a hydrocarbon in air and a hydrocarbon such as phthalate ester generated from a retaining box and the like.

In order to achieve an aspect of the present invention, a retaining box of a semiconductor wafer, includes: an air supply port which has a piping joint and a first filter and through which air is forcedly supplied; and an exhaust port which has a second filter and from which inner air inside the retaining box is exhausted, and wherein the retaining box accommodates a plurality of semiconductor wafers in an interval between each other.

In this case, when a semiconductor wafer is accommodated in the retaining box, a pipe guiding clean air or clean gas is connected to the piping joint such that the clean air or the clean gas can be forcedly supplied from the air supply port to the retaining box, and the clean air or the clean gas can be further exhausted from the exhaust port.

Also in this case, clean air or clean gas can be forcedly supplied from the air supply port to the retaining box, and the clean air or the clean gas can be further exhausted from the exhaust port such that an air flow that flows through the retaining box is generated.

Further in this case, a body of the retaining box is made of a material including an organic matter, such as a material of a poly-carbonate system.

In this case, the first and second filters are ULPA filters.

Also in this case, the air supply port is placed near a top portion of the retaining box, and the exhaust port is placed on a first plane which is located near a bottom portion of the retaining box and opposite to a second plane on which the air supply port is placed.

Further in this case, an air flow supplied from the air supply port always flows from an upward position to a downward position and also flows towards the second plane to be exhausted from the exhaust port.

In this case, the piping joint is constituted by a one-touch joint.

Also in this case, the semiconductor wafer is horizontally arranged in the retaining box.

Further in this case, a body of the retaining box is made of a material including an organic matter, such as a material of a poly-carbonate system.

In this case, the first and second filters are ULPA filters.

Also in this case, the air supply port is placed near a top portion of the retaining box, and the exhaust port is placed on a first plane which is located near a bottom portion of the retaining box and opposite to a second plane on which the air supply port is placed.

Further in this case, an air flow supplied from the air supply port always flows from an upward position to a downward position and also flows towards the second plane to be exhausted from the exhaust port.

In order to achieve an aspect of the present invention, a conveying apparatus of a semiconductor wafer, includes: a retaining box accommodating a plurality of semiconductor wafers in an interval between each other; and a cylinder, and wherein the retaining box includes: an air supply port which has a piping joint and a first filter and through which air is forcedly supplied; and an exhaust port which has a second filter and from which inner air inside the retaining box is exhausted, and wherein the cylinder has an air supply joint connectable to the piping joint to supply clean air or clean gas to the retaining box, and wherein the conveying apparatus of the semiconductor wafer is used to convey the retaining box that the plurality of semiconductor wafers are accommodated.

In order to achieve another aspect of the present invention, a semiconductor wafer taking out method, includes: providing a retaining box which accommodates a semiconductor wafer and includes an air supply port through which air is forcedly supplied and an exhaust port from which inner air inside the retaining box is exhausted and a door which is opened when the semiconductor wafer in the retaining box is taken out from the retaining box; providing a feeding apparatus into which clean gas is introduced, wherein the feeding apparatus has a opening and the semiconductor wafer is taken out through the door which is opened and the opening from the retaining box to be supplied to the feeding apparatus; introducing clean gas into the feeding apparatus before the door is opened; supplying air through the air supply port to the retaining box before the door is opened; forming air seal or air curtain with the clean gas introduced into the feeding apparatus and the air supplied to the retaining box, wherein the clean gas and the air of the air seal or the air curtain is exhausted from the exhaust port; and opening the door to take out the semiconductor wafer from the retaining box to be supplied to the feeding apparatus after forming the air seal or the air curtain.

In order to achieve still another aspect of the present invention, a retaining warehouse of a semiconductor wafer, includes: a plurality of retaining boxes provided in the retaining warehouse, each of the plurality of retaining boxes accommodating a plurality of semiconductor wafers, wherein the retaining box includes an air supply port which has a piping joint through which air is supplied and an exhaust port which has a second filter and from which inner air inside the retaining box is exhausted; a pipe through which clean air or clean gas is supplied; and a plurality of air supply joints that can be connected to the pipe and connected to a plurality of the piping joints, respectively.

In this case, clean air or clean gas can be forcedly supplied from the air supply port to the retaining box, and the clean air or the clean gas can be further exhausted from the exhaust port such that an air flow that flows through the retaining box is generated.

Also in this case, a body of the retaining box is made of a material including an organic matter, such as a material of a poly-carbonate system.

Further in this case, the air supply port is placed near a top portion of the retaining box, and the exhaust port is placed on a first plane which is located near a bottom portion of the retaining box and opposite to a second plane on which the air supply port is placed.

In order to attain the above-mentioned object, the retaining box of the semiconductor wafer in the present invention is characterized in that in the retaining box of the semiconductor wafer for accommodating a plurality of semiconductor wafers in an interval between each other, it includes: an air supply port which has a piping joint and a filter and through which air is forcedly supplied from an external portion; and an exhaust port which has at least a filter and from which inner air is exhausted.

According to the retaining box of the semiconductor wafer in the present invention, when the semiconductor wafer is accommodated in the retaining box, since a pipe for guiding clean air or clean gas is merely connected to the piping joint of the air supply port, the clean air or the clean gas can be forcedly supplied from the supply port, and the clean air or the clean gas can be further exhausted from the exhaust port. Thus, the semiconductor wafer can be protected from the contamination caused by the dust from the external air and the organic matter such as the phthalate ester generated from the retaining box and the like. In particular, the design of generating an air flow that always or intermittently flows through the retaining box disables the organic gas generated from the retaining box to be deposited on the surface of the semiconductor wafer. Even once it is deposited on the surface of the semiconductor wafer, it is removed by the air flow. Hence, it is possible to effectively protect the surface of the semiconductor wafer from being contaminated because of the particle, the organic gas and the like.

By the way, the usage of the retaining box of the semiconductor wafer in the present invention is not limited to the typical semiconductor wafer. If it is a material to be cleanly retained, the retaining box can be used to retain all materials, products and half-finished products, such as a material itself, a semiconductor material in a manufacturing process, or a product or a half-finished product such as a liquid crystal and the like.

The body of the retaining box of the semiconductor wafer in the present invention may be made of any material. However, if it is made of a material including an organic matter, for example, a material of a poly-carbonate system, the effect of the present invention is very excellently provided. The filter used in the present invention is not limited in particular. However, a ULPA filter is especially desired from the viewpoint of its performance. It is enough that the piping joint can be connected to a pipe, a tube and the like through which the clean air or the clean gas is supplied. Thus, the piping joint is not limited to a particular shape and a special substance.

In a preferable example of the semiconductor wafer according to the present invention, the air supply port is placed near the top of the retaining box, and the exhaust port is placed on a plane which is located near the bottom of the retaining box and opposite to a plane on which the air supply port is placed. Due to the employment of such configuration, the air flow always flows from an upward direction to a downward direction and also flows towards the opposite plane. Thus, the particles and the organic gas follow it. In short, the particles passed through the filter and the organic gas generated inside the retaining box because of any reason are further effectively removed from the surface of the semiconductor wafer.

Also, in a preferable example of the present invention, the piping joint of the air supply port is constituted by a one-touch joint. In this case, the connection of the pipe through which the clean air or the clean gas is supplied can be especially easily carried out.

Moreover, the air flow may always or intermittently flow from the piping joint. In both of the cases, the molecules, the gas components and the particles can be effectively removed from the surface of the semiconductor wafer. Such air flow may be generated by an external clean air supplying apparatus or an external clean gas supplying apparatus, or it may be generated from the piping joint under an electrical control.

Moreover, preferably, the semiconductor wafer is horizontally arranged on the retaining box. The effect of the present invention is especially effectively provided in the retaining box in which the semiconductor wafer is horizontally arranged.

The feeding apparatus of the semiconductor wafer in the present invention is the semiconductor wafer feeding apparatus for accommodating the semiconductor wafer in the above-mentioned semiconductor wafer retaining box and feeding the semiconductor wafer, wherein it includes a cylinder which has an air supply joint connectable to the piping joint of the air supply port and then supplies the clean air or the clean gas from the air supply joint.

The employment of the feeding apparatus in the present invention enables the air flow to be always generated inside the retaining box even during the feeding operation. Thus, it is possible to effectively protect the particles and the organic matters from being deposited on the surface of the semiconductor wafer even during the feeding operation.

Also, the feeding method of the semiconductor wafer in the present invention is the method of accommodating the semiconductor wafer in the above-mentioned retaining box and then feeding the semiconductor wafer, wherein when a door of the retaining box is opened, the clean air or the clean gas is supplied from a front plane of the door, and inner air is naturally exhausted from the exhaust port. Due to the employment of such configuration, it is possible to effectively protect the external particles from being deposited on the surface of the semiconductor wafer, even when the door is opened.

The retaining warehouse of the semiconductor wafer in the present invention is the semiconductor wafer retaining warehouse for accommodating the semiconductor wafer in the above-mentioned retaining box in the present invention, wherein it is provided with: the pipe through which the clean air or the clean gas is supplied; and a plurality of air supply joints that can be connected to the pipe and connected to the joints of the air supply port, respectively. In the retaining warehouse in the present invention, even if the retaining box is retained in the retaining warehouse for a relatively long period, the air flow is always or intermittently generated inside the retaining box. Thus, it is possible to effectively protect the external particles, the organic matters generated inside the retaining box and the like from being deposited on the surface of the semiconductor wafer. Incidentally, the retaining warehouse is not limited to the particular warehouse. It may be a place in which the retaining box accommodating the semiconductor wafer is transiently retained.

### BRIEF DESCRIPTION OF THE DRAWINGS

FIG. 1 is a side section view showing a conventional retaining box of a semiconductor wafer;

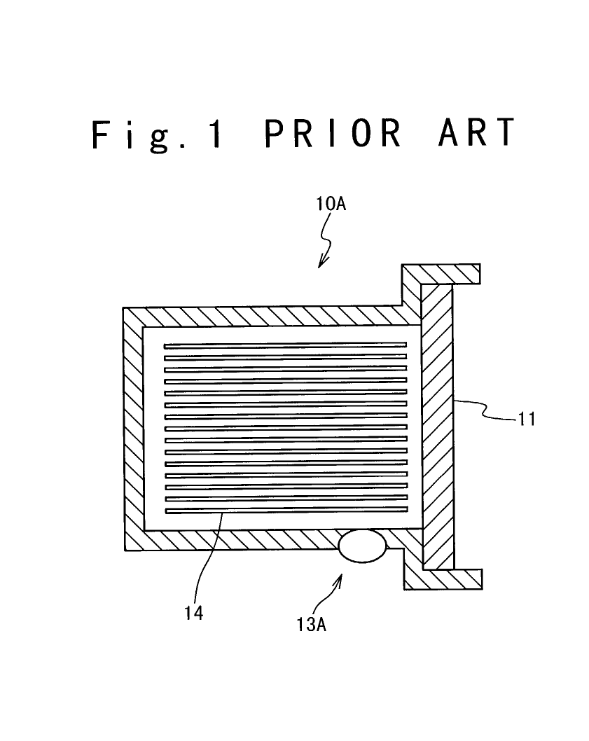

FIG. 2 is a section view showing a manner when a semiconductor wafer is taken out, in a load port constituting a part of a conventional semiconductor wafer feeding apparatus;

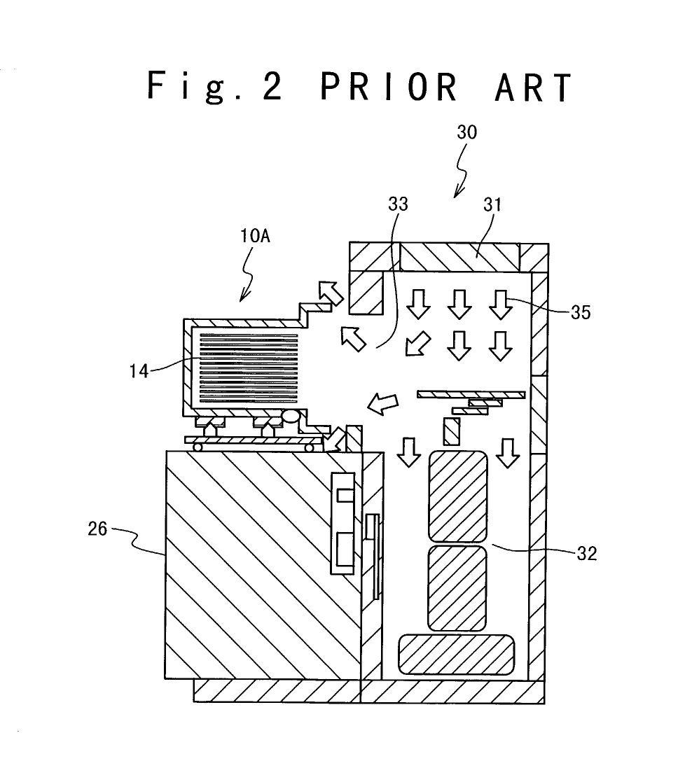

FIG. 3 is a side section view showing a retaining box of a semiconductor wafer according to an embodiment in the present invention;

FIG. 4 is a side section view showing a retaining warehouse according to an embodiment in the present invention; and

FIG. 5 is a section view showing a manner when a semiconductor wafer is taken out, in a load port constituting a part of a feeding apparatus according to an embodiment in the present invention.

### DESCRIPTION OF THE PREFERRED EMBODIMENTS

Embodiments of the present invention will be described below with reference to the drawings.

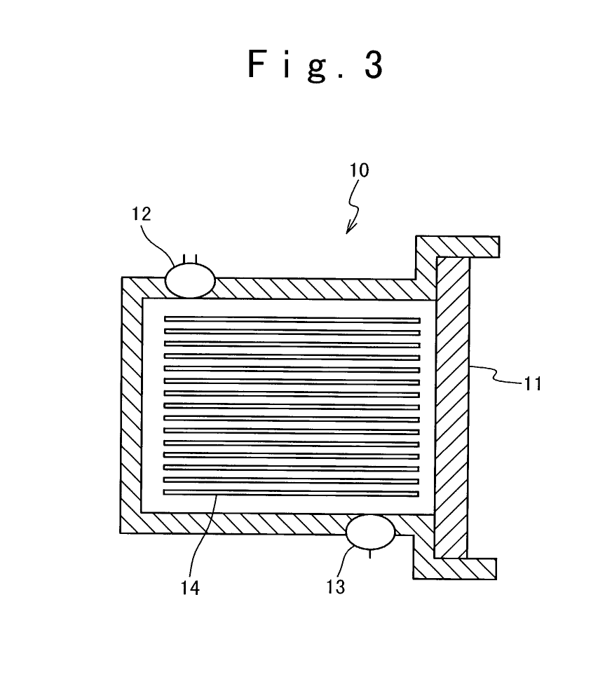

The present invention will be described below in detail on the basis of a preferable embodiment in the present invention with reference to the drawings. FIG. 3 is a side section view showing a retaining box of a semiconductor wafer according to an embodiment in the present invention. A retaining box 10 is made of polycarbonate resin material, and it has the shape of a rectangular parallelepiped with a size of about 400 mm³ as a whole, and includes a door 11 on a front surface in order to accommodate/take out the semiconductor wafer. A piping joint 12 to be connected to a pipe through which clean air or clean gas (hereafter, referred to as clean gas, including both of them) is formed in the vicinity of a rear of a top surface of the retaining box 10, and a ULPA filter is attached inside the piping joint 12. A valve may be attached to the piping joint 12.

An exhaust port 13 for natural exhaust is formed in the vicinity of the front door 11 on the bottom of the retaining box 10. The ULPA filter is attached inside the box of the exhaust port 13. The semiconductor wafers 14 are placed on the racks, which are formed so as to be protruded from both sides inside the retaining box 10 and extended in forward and backward directions of the retaining box 10 and arrayed in a vertical direction. For example, 25 semiconductor wafers are horizontally accommodated in one retaining box 10 at one time.

The retaining box 10 in the embodiment can be especially preferably used when the semiconductor wafer 14 is fed between a certain process step and a process step following it, in the process for manufacturing the semiconductor wafer. A cylinder filled with the clean gas is prepared in the feeding apparatus containing a plurality of retaining boxes 10, and a plurality of hoses are connected to discharging plugs of the cylinder. A tip of the hose is connected to the piping joint of the air supply port 12 of each retaining box 10. The clean gas from the cylinder may be always or intermittently supplied. The clean gas is exhausted from the exhaust port 13 by the natural exhaust.

The particles stripped off from the inner wall made of the polycarbonate resin in the retaining box 10, or the organic matter or the organic gas that is degassed from the inner wall and is floating inside the retaining box 10 is introduced by the air flow which flows downwardly from above the box and flows towards a forward direction, and it is never deposited on the surface of the semiconductor wafer 14. Also, even a light organic matter once fallen on the surface of the semiconductor wafer 14 is moved on the surface of the wafer by the air flow, and fallen in an edge of the wafer, and then introduced into the exhaust port 13.

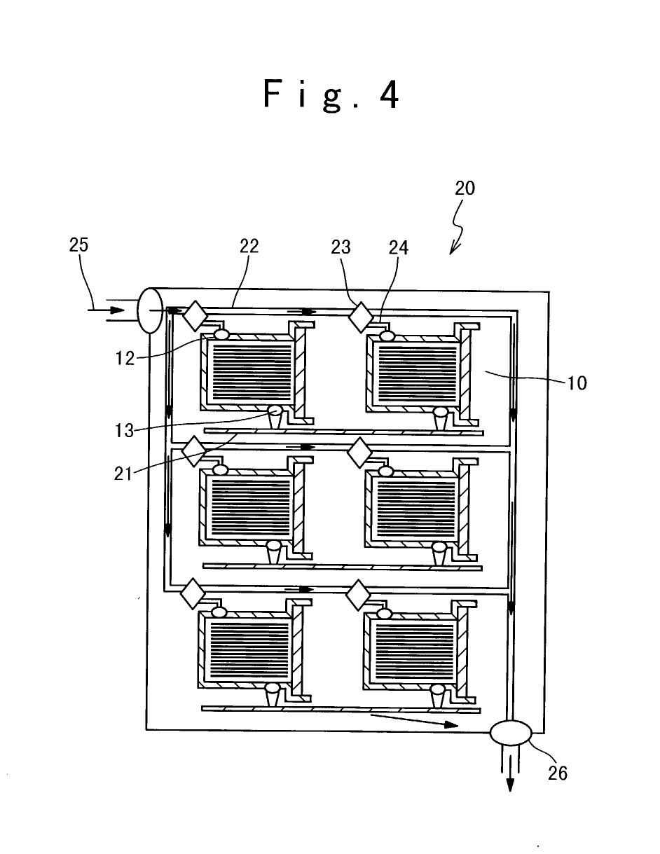

FIG. 4 shows the manner when the retaining box 10 in the embodiment is accommodated in a retaining warehouse 20, by using a section view of a warehouse. A plurality of stages of floors 21 to place the retaining boxes 10 are placed inside the warehouse 20, and each retaining box 10 is retained on a corresponding floor 21. A clean gas pipe 22 extended in the placed direction of the retaining box 10 is fixed along each floor 21 inside the retaining warehouse 20. A cock 23 and a hose 24 are placed correspondingly to a position of each retaining box 10. Then, when the retaining box 10 is placed, the hose 24 is connected to the piping joint of that supply port 12. A clean gas 25 is supplied to the clean gas pipe 22 from a clean gas supplying apparatus (not shown). The clean gas exhausted from the exhaust port 13 of each retaining box 10 is exhausted through an exhaust port 26 formed on the warehouse 20.

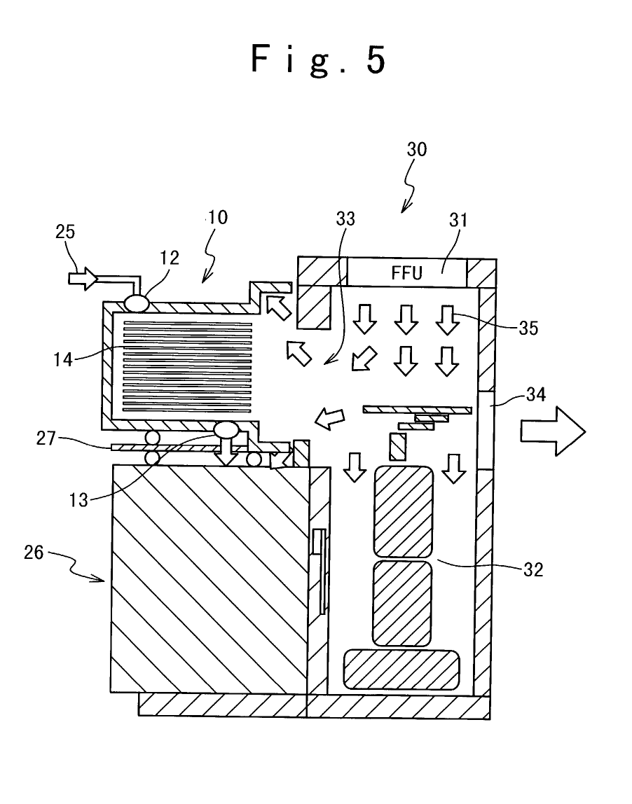

FIG. 5 shows the manner when the semiconductor wafer is taken out from the retaining box 10 through the load port constituting the feeding apparatus. The retaining box 10 is inserted into the vicinity of the load port 30 by a feeding carriage 27. The load port 30 has a blower unit 31 having a fan and a HEPA filter at that top. Then, while the clean gas is introduced into the load port 30 by the fan, a wafer loader 32 is actuated to thereby take out the semiconductor wafers 14 from the retaining box 10 through a carrying inlet 33, one by one. The semiconductor wafers 14 taken out by the wafer loader 32 are fed to a next process shown on the right side of FIG. 5, through a carrying outlet 34 of the load port 30, one by one. The load port 30 is designed such that before the door of the retaining box 10 is opened, the blower unit 31 is actuated to thereby introduce a clean gas 35, and before the door is opened, the clean gas 25 is similarly introduced into the retaining box 10 from the air supply port 12. The clean gases 25, 35 form the air seal between the carrying inlet 33 of the load port 30 and the front surface of the retaining box 10, and a positive pressure protects the invasion of the external particles. Also, a part of the clean gases 25, 35 is exhausted from the exhaust port 13 at the lower portion of the retaining box 10. After the operation for taking out the semiconductor wafers 14 from the retaining box 10 is ended and the door is closed, the introduction of the clean gas is stopped.

According to the retaining box 10, the retaining warehouse 20 and the load port (feeding apparatus) 30 of the semiconductor wafer according to the embodiment, the atmosphere in the semiconductor wafer is kept clean during the retaining and the feeding thereof. In particular, even if the organic matter from the retaining box 10 is exhausted as out gas, this out gas is exhausted from the exhaust port by the cleaned gas flow. Thus, the staying time of the out gas can be shortened to thereby protect the contamination caused by the out gas over the surface of the semiconductor wafer 14. Also, the invasion of the external particles can be effectively protected.

As mentioned above, the present invention has been explained on the basis of the preferable embodiment. However, the retaining box, the feeding apparatus, the feeding method and the retaining warehouse of the semiconductor wafer in the present invention are not limited to the configurations of the embodiment. The configurations on which the various modifications from the embodiment are performed are included in the range of the present invention. For example, the retaining box of the present invention is not limited to the example of the front door. For example, it can be also applied to a retaining box whose bottom functions as a door. Also, the retaining box of the present invention is not limited to the retaining of the semiconductor wafer. It can retain the various materials requiring the cleanliness level similar to that of the semiconductor wafer, the half-finished products and the finished products.

As mentioned above, according to the retaining box of the semiconductor wafer in the present invention, the air flow can be forcedly generated always or intermittently inside the retaining box. Thus, it is possible to effectively protect the particle and the organic matter from being deposited on the surface of the semiconductor wafer.

Also, the usage of the feeding apparatus, the feeding method or the retaining warehouse of the semiconductor wafer in the present invention enables the function of the retaining box to be further effectively provided.

What is claimed is:

1. A retaining box of a semiconductor wafer, comprising:
an air supply port which has a piping joint and a first filter and through which air is forcedly supplied; and
an exhaust port which has a second filter and from which inner air inside said retaining box is exhausted, and
wherein said retaining box accommodates a plurality of semiconductor wafers in an interval between each other.

2. The retaining box of a semiconductor wafer according to claim 1, wherein when a semiconductor wafer is accommodated in said retaining box, a pipe guiding clean air or clean gas is connected to said piping joint such that said clean air or said clean gas can be forcedly supplied from said air supply port to said retaining box, and said clean air or said clean gas can be further exhausted from said exhaust port.

3. The retaining box of a semiconductor wafer according to claim 1, wherein clean air or clean gas can be forcedly supplied from said air supply port to said retaining box, and said clean air or said clean gas can be further exhausted from said exhaust port such that an air flow that flows through said retaining box is generated.

4. The retaining box of a semiconductor wafer according to claim 1, wherein a body of said retaining box is made of a material including an organic matter, such as a material of a polycarbonate system.

5. The retaining box of a semiconductor wafer according to claim 1, wherein said first and second filters are ULPA filters.

6. The retaining box of a semiconductor wafer according to claim 1, wherein said air supply port is placed near a top portion of said retaining box, and said exhaust port is placed on a first plane which is located near a bottom portion of said retaining box and opposite to a second plane on which said air supply port is placed.

7. The retaining box of a semiconductor wafer according to claim 6, wherein an air flow supplied from said air supply port always flows from an upward position to a downward position and also flows towards said second plane to be exhausted from said exhaust port.

8. The retaining box of a semiconductor wafer according to claim 1, wherein said piping joint is constituted by a one-touch joint.

9. The retaining box of a semiconductor wafer according to claim 1, wherein said semiconductor wafer is horizontally arranged in said retaining box.

10. The retaining box of a semiconductor wafer according to claim 3, wherein a body of said retaining box is made of a material including an organic matter, such as a material of a polycarbonate system.

11. The retaining box of a semiconductor wafer according to claim 3, wherein said first and second filters are ULPA filters.

12. The retaining box of a semiconductor wafer according to claim 3, wherein said air supply port is placed near a top portion of said retaining box, and said exhaust port is placed on a first plane which is located near a bottom portion of said retaining box and opposite to a second plane on which said air supply port is placed.

13. The retaining box of a semiconductor wafer according to claim 12, wherein an air flow supplied from said air supply port always flows from an upward position to a downward position and also flows towards said second plane to be exhausted from said exhaust port.

14. A conveying apparatus of a semiconductor wafer, comprising:
a retaining box accommodating a plurality of semiconductor wafers in an interval between each other; and
a cylinder, and
wherein said retaining box includes:
an air supply port which has a piping joint and a first filter and through which air is forcedly supplied; and
an exhaust port which has a second filter and from which inner air inside said retaining box is exhausted, and
wherein said cylinder has an air supply joint connectable to said piping joint to supply clean air or clean gas to said retaining box, and
wherein said conveying apparatus of said semiconductor wafer is used to convey said retaining box that said plurality of semiconductor wafers are accommodated.

15. A semiconductor wafer taking out method, comprising:
providing a retaining box which accommodates a semiconductor wafer and includes an air supply port through which air is forcedly supplied and an exhaust port from which inner air inside said retaining box is exhausted and a door which is opened when said semiconductor wafer in said retaining box is taken out from said retaining box;
providing a feeding apparatus into which clean gas is introduced, wherein said feeding apparatus has a opening and said semiconductor wafer is taken out through said door which is opened and said opening from said retaining box to be supplied to said feeding apparatus;
introducing clean gas into said feeding apparatus before said door is opened;
supplying air through said air supply port to said retaining box before said door is opened;
forming air seal or air curtain with said clean gas introduced into said feeding apparatus and said air supplied to said retaining box, wherein said clean gas and said air of said air seal or said air curtain is exhausted from said exhaust port; and
opening said door to take out said semiconductor wafer from said retaining box to be supplied to said feeding apparatus after forming said air seal or said air curtain.

16. A retaining warehouse of a semiconductor wafer, comprising:
a plurality of retaining boxes provided in said retaining warehouse, each of said plurality of retaining boxes accommodating a plurality of semiconductor wafers, wherein said retaining box includes an air supply port which has a piping joint through which air is supplied and an exhaust port which has a second filter and from which inner air inside said retaining box is exhausted;
a pipe through which clean air or clean gas is supplied; and
a plurality of air supply joints that can be connected to said pipe and connected to a plurality of said piping joints, respectively.

17. The retaining warehouse of a semiconductor wafer according to claim 16, wherein clean air or clean gas can be forcedly supplied from said air supply port to said retaining box, and said clean air or said clean gas can be further exhausted from said exhaust port such that an air flow that flows through said retaining box is generated.

18. The retaining warehouse of a semiconductor wafer according to claim 16, wherein a body of said retaining box is made of a material including an organic matter, such as a material of a polycarbonate system.

19. The retaining box of a semiconductor wafer according to claim 16, wherein said air supply port is placed near a top portion of said retaining box, and said exhaust port is placed on a first plane which is located near a bottom portion of said retaining box and opposite to a second plane on which said air supply port is placed.
